(19) United States
(12) Patent Application Publication
(10) Pub. No.: US 2017/0370420 A1
(43) Pub. Date: Dec. 28, 2017

(54) Universal Joint

(71) Applicant: Ulterra Drilling Technologies, L.P., Fort Worth, TX (US)

(72) Inventors: Carl Aron Deen, Fort Worth, TX (US); Justin S. McMillan, Fort Worth, TX (US)

(21) Appl. No.: 15/636,469

(22) Filed: Jun. 28, 2017

Related U.S. Application Data
(60) Provisional application No. 62/355,589, filed on Jun. 28, 2016.

(51) Int. Cl. F16D 3/72; E21B 17/05; F16D 3/02; F16D 3/18

(52) U.S. Cl. CPC F16D 3/72; F16D 3/18; E21B 17/05; F16D 3/02

(57) ABSTRACT

A universal joint assembled in a drill string transfers torque between two shafts where the shafts are not completely aligned. The universal joint includes a cable that passes through joint components. The cable limits separation or deflection of the joint components.

### RELATED APPLICATION

This application claims the benefit of U.S. Provisional Application No. 62/355,589, filed Jun. 28, 2016, entitled, “Universal Joint,” which is incorporated herein in its entirety by reference for all purposes.

### FIELD OF THE INVENTION

This invention relates generally to universal joints used in downhole drill strings.

### GENERAL BACKGROUND

In a drilling operation, a drill bit is mounted to the end of a drill string. The drill string is rotated from the top of the string or by a motor at the bottom of the string, or both, to rotate the drill bit and advance the borehole. Eccentricity in the drill string may he initiated by a motor in the drive assembly that rotates the drill bit or by steering of the bit to change direction of the borehole. The eccentric rotation must be converted into concentric rotation in order for the drill bit to advance the borehole efficiently. Universal joints are included in the drill string to accommodate eccentricity in the string.

FIG. 1 is a schematic representation of a drilling operation 2. In conventional drilling operations, a drill bit 8 is mounted on the lower end of a drill string 6 comprising drill pipe and drill collars. The drill string may be several miles long and the hit is rotated in the borehole 4 either by a motor proximate the bit or by rotating the drill string, or both simultaneously. A pump circulates drilling fluid through the drill pipe and out of the drill hit to flush rock cuttings from the bit and move them back up the annulus of the borehole. The drill string comprises sections of pipe that are threaded together at their ends to create a pipe of sufficient length to reach the bottom of the borehole 4. Additional tools 10′ can be accommodated in the drill string such as mud motors, universal joints, reamers or vibrators to limit friction with the drill string.

The components of the drill string including the universal joint are subjected to extreme torque forces, elevated operating temperatures and abrasive drilling fluids, all of which can have an adverse effect on the operational life of drill string components. The constant relative movement of the components of the universal joint, together with abrasive drilling mud, causes abrasion and erosion of mating components.

Components of a joint can be joined and/or maintained in sequence by pins passing transversely through the components. The pins are loosely held to allow for relative movement of the components but are subject to bending, fracture and fatigue failures from repeated stress. The pins are also subject to erosion and wear from the abrasive drilling fluids. Transverse holes in the components of the joint to receive the pins remove material at critical areas, reducing the strength of the components and torsional load capacity.

Operational failure of the joint or its components requires removal of the drill string from the borehole and downtime for the operation which increases operational expenses substantially. A universal joint that is less vulnerable to abrasion and erosion with an extended service life would be advantageous.

### SUMMARY OF THE INVENTION

The present invention provides a universal joint to be used as part of a downhole drill string. The universal joint converts eccentric rotation of an output shaft such as a mud motor to axial rotation to drive a downhole tool more efficiently.

In one embodiment, a cable passes through each of the components along the joint axis to maintain the alignment of the components with the joint in tension. This can eliminate the need for pins passing transversely through the components that are subject to wear, fatigue failure and fracture. A cable can be more resilient with a longer service life than pins.

In one aspect of an embodiment of the present invention, an untensioned mail retains components of a universal joint.

In an alternative embodiment, a cable limits deflection of a monolithic body of a universal joint to an elastic range.

In an alternative embodiment, a universal joint for a downhole drill string comprises an upper joint member with a first axis and a lower joint member with a second axis transverse to the first axis. An untensioned cable passing through the upper and lower joint member to maintain the members in sequenced positions. The upper joint member pivots about the lower joint member at a pivot point and the first axis and second axis coincide at the pivot point.

In an alternative embodiment, a universal joint for a downhole drill string comprises an upper joint member with a first axis, a lower joint member with a second axis and a hearing spacing the members. A cable passes through the upper and lower joint members and bearing member to limit separation of the members.

In an alternative embodiment, a universal joint assembly for a drill string includes two components defining a cavity. The cavity retains a bearing member which transfers axial force from one component to the other. A cable passes through an opening in the two components and the bearing member to provide limited separation of the two components.

In an alternative embodiment, an inventive joint assembly includes first and second bodies each with longitudinally extending interlocking arms at one end and a threaded connector at the opposite end spaced from the arms. An internal blind bore extends between the arms of each body toward the connectors. With the bodies axially aligned and the arms intermeshed, the blind bores retain a ball bearing between first and second seats. A cable passing through the first and second bodies and the ball bearing provides limited axial separation of the joint components and ensures the ball hearing and seats are retained in the bore.

In another embodiment torque is transferred from the first member to the second member by the cable.

In an alternative embodiment, the upper joint member has longitudinally extending arms and the lower joint member has longitudinally extending arms. The arms of the upper and lower joint members are maintained in intermeshed position by an untensioned cable. In an alternative embodiment openings for the cable are contoured to limit interference with the cable.

### BRIEF DESCRIPTION OF THE DRAWINGS

FIG. 1 is a schematic view of a drilling operation.

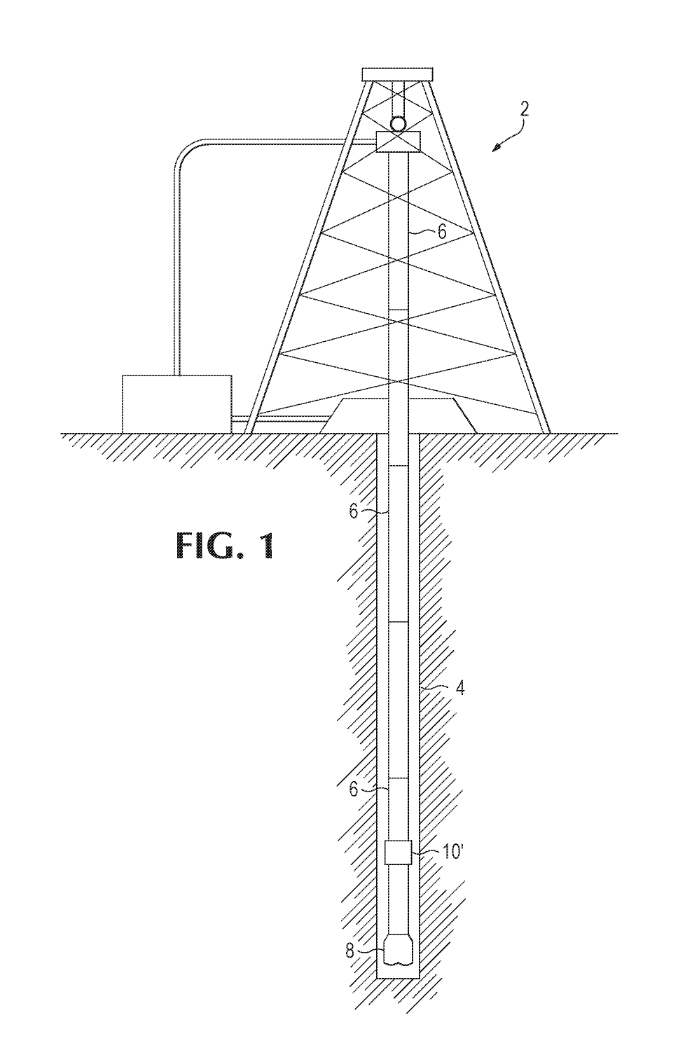

FIG. 2 is an exploded perspective view of the joint.

FIG. 3 is a cross section view of the joint.

FIG. 4 is a cross section view of the universal joint with the upper member rotated in relation to the lower member.

FIG. 5 is a cross-section view of a tool with two aligned universal joints.

FIG. 6 is a side view of an alternative embodiment of a universal joint.

### DETAILED DESCRIPTION OF THE PREFERRED EMBODIMENT

A drill string in its basic form consists of sections of threaded pipe assembled end. to end with a drill bit at a distal end for advancing a borehole. The drill string can be miles long and rotated at a proximal end of the pipe by a drilling rig to turn the drill bit and advance the borehole. Many kinds of components can be included in the drill string to perform a range of functions such as reaming out obstructions from the borehole, widening the borehole and motors at the distal end to rotate the drill bit.

Mud motors can be installed near the drill bit to drive the drill bit instead of, or in addition to, driving the drill string from the above ground drill rig. Fluid is pumped down the drill string during operation under very high pressure to flush material out of the borehole. A mud motor uses the pressure of the fluid to drive the motor and rotate a drive shaft. The output of the motor is eccentric, with the output shaft rotating about a circle as well as rotating about its axis. In order to limit the stress on the drill string and bit, one or more universal joint is installed as part of the drill string. The universal joint transmits the torque and the axial force of the drill string to the drill bit and can mitigate the eccentric rotational component from the drill string motion.

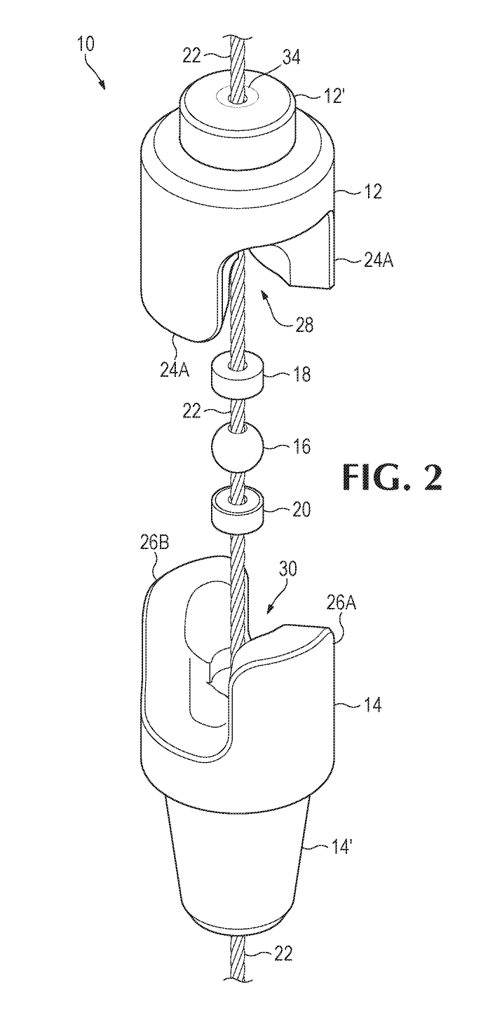

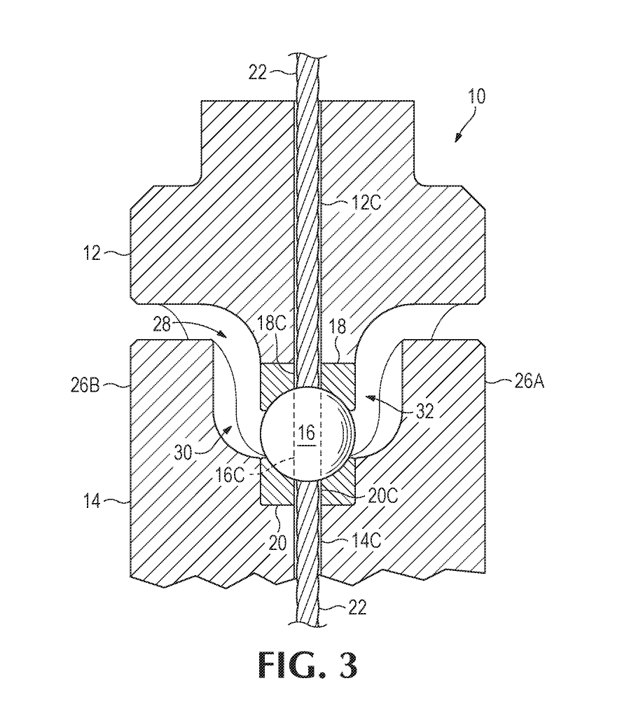

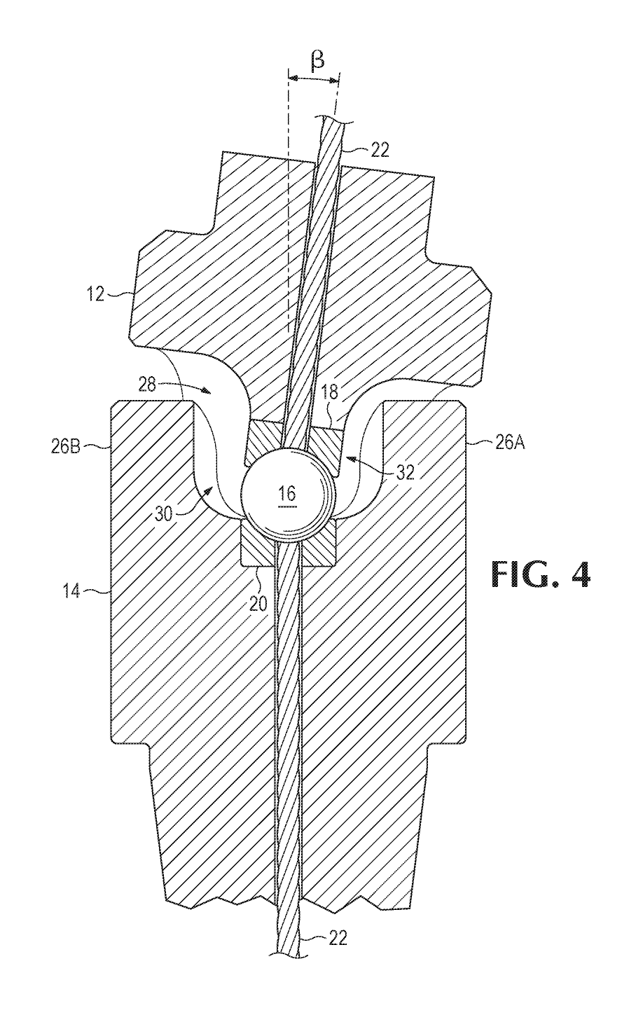

A universal joint of one embodiment of the invention is generally shown in FIGS. 2-6. The universal joint can be a loosely joined set of components maintained in general alignment or sequence by a cable. The joint can transmit torque and axial forces and can simultaneously flex to compensate for misalignment of transmitting and receiving elements. The joint is described in relation to a mud motor for purpose of illustration. The joint described can be used in other applications.

The universal joint assembly 10 includes a top joint member 12 and a bottom joint member 14. Top member 12 has a component connector 12′ at one end for joining to a drill string and axially extending arms 24A and 24B at the opposite end spaced from the connector. Arms 24A and 24B are spaced from each other to form a channel 28 that opens generally downward. Bottom member 14 has a corresponding construction with a component connector 14′ at one end and arms 26A and 26B at the opposite end and spaced from each other to form a channel 30 generally opening upward. Top and bottom joint members 12 and 14 can be loosely retained one to the other by an untensioned rope or cable 22 that passes through an opening in each of the members 12C, 14C.

The component connectors 12′, 14′ can be American Petroleum Institute (API) conforming threaded boxes or pins, or any appropriate (threaded) connection. Top and bottom members 12 and 14 each have a longitudinal axis, LA1 and LA2. The arms of each member extend generally parallel to the respective longitudinal axis; the connector is coaxial with the longitudinal axis. The top and bottom members 12 and 14 assemble together with arms of the top and bottom members intermeshing to form the universal joint assembly 10. Top and bottom joint members 12, 14 are preferably identical but could have different constructions. Although a specific configuration is described, this is an example for the purpose of illustration. Other types of joints with different configurations can take advantage of the inventive features.

The channels 28 and 30 when assembled mesh or overlap to form a generally cylindrical cavity 32. The arms are sized so that they do not completely fill the gap between the corresponding opposite arms when intermeshed. Space between adjacent arms allows the top and bottom members to move and pivot relative to each other without binding. The range of motion can be limited by the clearance between the arms.

The top and bottom members when intermeshed can retain a bearing element 16 between a top bearing face of a seat 18 and a bottom bearing face of a seat 20 in cavity 32. Seats 18, 20 are preferably secured in the central closed portions of the channels 28, 30 of the respective top and bottom members 12, 14 to define bearing surfaces facing each other, though discrete seats are not necessary. Joint members 12 and 14 can be loosely retained one to the other by a rope or cable 22 that passes through an opening in each of the members 12C, 14C, the seats 8C and 20C and the ball bearing 16C. The cable can terminate at the members or can extend through the connectors.

The cable can be a stranded rope, a flexible rod or other structure that performs a similar function. The cable can be metal, plastic, fiber or other materials or a combination of different materials. The properties of the cable material should exceed the expected loads applied. to cable and universal joint. The cable can include elastic properties to resiliently absorb an applied force without mechanical shock.

The joint assembly can include a fitting 34 for joining cable 22 to assembly 10. The fitting can be a thicker section of the cable wider than the passages of one or more of the components providing an interference fit that limits movement of the component along the cable. Alternatively, an intermediate or terminal fitting can secure the component to or along the cable.

Methods for making a fitting on a cable are well known by those skilled in the art. Methods include inserting a wedge between the strands of the cable. A tapered sheath over the outside of the wire can be used to compress the wire and wedge. Alternatively, fittings can be swaged to the cable.

Alternatively, an intermediate fitting can form a sheath around a metal cable adjacent a component. Molten metal poured in the sheath bonds the metal cable to the sheath surface and retain the cable. Cables that comprise polymer or natural fiber strands can be infiltrated with epoxy as a fitting. Alternatively, the cable can be bonded to a component by soldering, gluing or welding. Alternatively, the fitting can be a pin or shaft passing through the component and cable to connect the cable to the component. End member connectors can be attached to the cable such as a threaded coupling, ferrule, eye, thimble or any similar fitting that limits motion of components on the cable. Other fittings used to limit motion of components on the cable are possible. A combination of different fitting types can be incorporated in a joint assembly.

Depending on the configuration of the components and fittings, the components can slide on the cable until contacting a wide portion of the cable. Where components are secured to the cable, upper and lower members can move to spaced positions as slack in the cable is taken up.

The upper member can pivot about the ball bearing with the ball bearing on seats 18 and 20. The cable 22 flexes to accommodate rotation and pivoting of the members. Rotation can be measured as the angular deflection “β” of the longitudinal axis LA1 of the upper member in relation to the longitudinal axis LA2 of the lower member. Angular deflection of member 12 in relation to member 14 can be about a pivot point at the center of ball hearing 16. The longitudinal axes LA1 and LA2 generally intersect at the pivot point as member 12 and member 14 pivot in relation to each other. In some embodiments motion of the upper member in relation to the lower member can include translation transverse to the longitudinal axis.

As torque is applied to the upper end of the universal joint in a drill string, the upper member rotates about the longitudinal axis in relation to the lower member until the intermeshing arms make contact on one side of each arm and torque is applied to the lower member. The lower member will then begin to rotate and the applied torque transferred to the components lower in the drill string. Axial force applied to the upper member passes through the upper element, to the upper seat in the cavity, to the ball bearing, to the lower seat and into the lower member. The seat and the ball bearing concentrate the axial force at the contact faces. Both the seat and the ball bearing are preferably made of hard materials to keep from deforming and wear at the contact points. Materials for seats and ball bearings can include case hardened steel, chrome steel, stainless steel and ceramics such as silicon nitride. The seats may be a hybrid material with a body of softer metal and a bearing surface that contacts the ball bearing of a harder material.

When the upper member is assembled to the lower member, the members can be sized so that the member arms do not bottom out before the seat and ball bearing meet in the cavity. The seats and ball bearing carry the axial load through the universal joint. Although the arms of the upper and lower elements can contact the adjacent arms on one side during operation to transfer torque, the arms are maintained in a generally spaced axial relationship on the other side so that the members maintain relative movement without binding against each other.

The openings that accept the cable can form an interference fit or a tight fit with the cable. Alternatively the openings can he larger than the diameter of the cable. The openings can be tapered to allow the joint component to pivot without binding of the cable. Other opening configurations are possible. A cable can have a bending limit where strands fracture or the cable takes on a permanent set that can distort the alignment of components. The passages in the joint components can be configured to limit the radius of curvature during bending of the cable. The openings can have a curved or rounded transition to the component surface to limit damage to the cable.

The universal joint may be part of an assembly inside the drill string so that there is an outer casing of the drill string with components inside such as the mud motor and universal joint. In some embodiments, the assembly may be extracted from the inside of the drill string and brought to the surface as a separate unit. When tension is applied to the universal joint at the upper member, the ball bearing and the seats can separate. The cable 22 limits separation of the upper and lower members. The upper and lower members move apart until cable 22 is in tension and adjacent components are at least slightly spaced. The upper and lower member arms can be maintained in intermeshed relation and the ball bearing and the seats retained in the cavity while tension is applied to the joint. Other operations such as driving the fluid flow in reverse in the drill string can also put the universal joint in tension, as well as disassembly of the motor for servicing.

In an alternative embodiment, the upper and lower members do not have arms and do not bear on each other to transmit torque. Torque applied to the upper member can be transferred to the lower member by shear stress in the cable. Initially, there can be relative rotational movement between the upper and lower member as torque is applied to the assembly and the untensioned cable twists until it is in tension. The cable then transfers torque to the lower member and rotation of the upper member in relation to the lower member is limited. The upper member while transferring torque can pivot about the lower member.

Alternatively, the upper and lower members can have meshing arms and the cable transfers a portion of the torque to the lower member. The cable initially transfers torque to the lower member as the cable twists and tension increases in the cable until the arms make contact and the balance of the torque is carried by the arms. The spacing between the arms can be increased to allow the cable to absorb more torque.

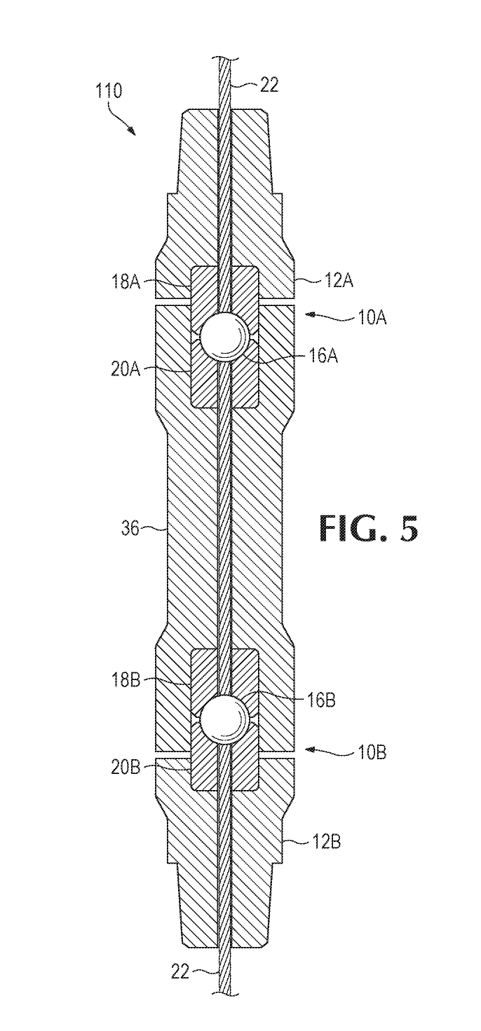

In an alternative embodiment a universal joint assembly 110 can include two or more subassemblies of joints 10A and 10B as shown in FIG. 5. Each of the joints can be similar to those previously described. The assembly 110 includes upper subassembly joint 10A with upper member 12A and middle member 36 separated by a ball bearing 16A and seats 18A and 20A. The assembly 110 includes lower subassembly 10B with lower member 12B separated from middle member 36 by a ball bearing 16B and seats 18B and 20B. An untensioned cable 22 can pass through each of the components to maintain alignment of the components when the assembly is under tension or when no axial force is applied to the assembly. Torque can be transferred by members bearing on each other with intermeshed arms of via the cable, each as described above.

The cable through the components provides for pivotal movement of the component with reduced risk of material failure generally experience by the pins or bolts, or reduced torsional load capacity from removal of material for retainer holes in conventional arrangements. In some embodiments the cable can transmit torque through the joint. An untensioned cable can be used with other types of joints used with misaligned components such as Oldham joints, magnetic couplings, jaw couplings and helical couplings.

In an alternative embodiment, tension is maintained on the cable by springs or other resilient members to limit sag in the cable during operation and prevent tangling of the loose cable.

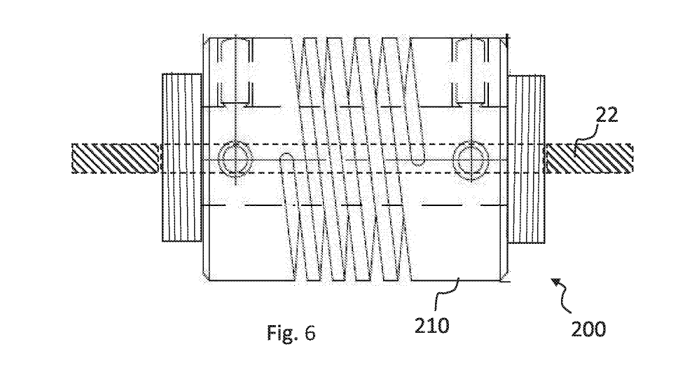

In general the range of motion of components in any specific application will be known and well defined, but the forces experienced by the bearing member are not always predictable in downhole applications. Where the universal joint experiences more extreme flexure or axial force or more wear than expected, the service life can be shorter than predicted. FIG. 6 shows a helical joint 200 with a flexible body 210 machined as a single monolithic unit, though other constructions are possible. A cable 22 secured at each end of the body is untensioned with the body in a relaxed position. With the body under axial tension or other force, the body can extend or bend with the coils flexing in response to the applied force. At a certain deflection of the body, the cable is under tension and limits additional deflection of the coupling body. The cable can limit plastic deformation of the coupling by limiting the deflection of the body. The cable can prevent damage to the joint by bending or plastic deformation and allow the joint to operate in a wider range of conditions without risk of damage.

It should be appreciated that although selected embodiments of the representative universal joints are disclosed herein, numerous variations of these embodiments may be envisioned by one of ordinary skill that do not deviate from the scope of the present disclosure. The disclosure set forth herein encompasses multiple distinct inventions with independent utility. The various features of the invention described above are preferably included in each universal joint. Nevertheless, the features can be used individually in a joint to obtain some benefits of the invention. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed.

What is claimed is:

1. Apparatus for use in downhole operations comprising:
a top joint member with a first axis of rotation;
a bottom joint member with a second axis of rotation, the bottom joint member positioned with respect to the top joint member to receive torque from the top joint members;
a bearing element between the top joint member and the bottom joint member for transmitting compressive loads between the top joint member and the bottom joint member while permitting the top joint member and bottom joint member to pivot with respect to each other; and
a cable connecting the top joint member and the bottom joint member, extending through the bearing element, for preventing separation of the top joint member and the bottom joint member beyond a predetermined limit.

2. The apparatus of claim 1, further comprising:
a top fitting fixing the cable to the top joint member; and
a bottom fitting fixing the cable to the bottom joint member.

3. The apparatus of claim 1, wherein
the top joint member, the bottom joint member and bearing element form a first subassembly;
the joint further comprises a second subassembly below the first subassembly, the second subassembly comprising a top joint member, a bottom member and a bearing element between the top member and the bottom member; and
the top joint member of the second subassembly is coupled for rotation with the bottom member of the first subassembly, and the cable extends through the first subassembly and the second subassembly.

4. The apparatus of claim 1, wherein the cable is not tensioned.

5. The apparatus of claim 1, wherein the bearing element comprises a ball bearing having a bearing element opening extending entirely through the bearing element, through the cable extends.

6. The apparatus of claim 1, wherein top joint member and the bottom joint member comprise opposite ends of a helical joint having a helical body, wherein the bearing element comprises the helical body.

7. The apparatus of claim 6, wherein:
the helical body transfers torque;
the cable extends through helical body and is secured at each of the opposite ends of the helical body; and
the cable is untensioned when the helical body is in a relaxed position, thus allowing helical body to extend or bend in response to an applied force while limiting further deflection of the helical body when under tension.

8. The apparatus of claim 1, further comprising:
a first plurality of arms axially extending from the top joint member; and
a second plurality of arms axially extending from the bottom joint member;
wherein the first plurality of arms are intermeshed with the second plurality of arms for transmission of rotational motion between the top and bottom joint members.

9. The apparatus of claim 8, wherein the first plurality of arms and the second plurality of arms are not connected to each other with a fastener.

10. The apparatus of claim 1, wherein the top joint member and the bottom joint member form one of the following types of joints: Oldham joint, universal joint, magnetic coupling, jaw coupling and helical coupling.

11. The apparatus of claim 1, wherein the top joint member and the bottom joint member are configured for transferring at least a portion of torque applied to the upper member to the lower joint member by shear stress in the cable.

12. The apparatus of claim 11, wherein:
the top joint member and the bottom joint member have spaced apart, intermeshing arms that allow the top joint member and the bottom joint member to rotate with respect to each other a predetermined distance before the intermeshing arms contact; and
the cable initially transfers torque from the top joint member to the bottom joint member as the cable twists and tension increases in the cable until the arms make contact and a balance of the torque is carried by the arms.

13. Apparatus for use in downhole operations, comprising:
a drill string; and
a tool connected incorporated into the drill string;
wherein the tool comprises an articulating joint, and the articulating joint comprises:
a top joint member with a first axis of rotation;
a bottom joint member with a second axis of rotation, the bottom joint member positioned with respect to the top joint member to receive torque from the top joint members;
means for bearing between the top joint member and the bottom joint member for transmitting compressive loads between the top joint member and the bottom joint member while permitting the top joint member and bottom joint member to pivot with respect to each other; and.
a cable connecting the top joint member and the bottom joint member, extending through the means for bearing, for preventing separation of the top joint member and the bottom joint member beyond a predetermined limit.

14. The apparatus of claim 13 wherein the means for bearing comprises one of a ball bearing and a helical element.

15. The apparatus of claim 13 wherein the articulating joint further comprises a first plurality of arms axially extending from the top joint member; and a second plurality of arms axially extending from the bottom joint member, the first plurality of arms are intermeshed with the second plurality of arms for transmission of rotational motion between the top and bottom joint members.

16. The apparatus of claim 13, wherein the cable is not tensioned.

17. A method of transferring torque through an articulating joint in drill string within a well bore, the articulating joint comprising:
a top joint member with a first axis of rotation, a bottom joint member with a second axis of rotation, the bottom joint member positioned with respect to the top joint member to receive torque from the top joint members;
a bearing element between the top joint member and the bottom joint member for transmitting compressive loads between the top joint member and the bottom joint member while permitting the top joint member and bottom joint member to pivot with respect to each other; and
a cable connecting the top joint member and the bottom joint member, extending through the bearing element, for preventing separation of the top joint member and the bottom joint member beyond a predetermined limit;
the method comprising:
lowering the drill string into a wellbore; and
applying torque to the top joint member.

18. The method of claim 17 wherein the cable is not tensioned.

19. The method of claim 17, wherein the bearing element comprises a ball hearing having a bearing element opening extending entirely through the bearing element. through the cable extends.

20. The method of claim 17, wherein top joint member and the bottom joint member comprise opposite ends of a helical joint having a helical body; and wherein the bearing element comprises the helical body.

21. The method of claim 20, further comprising transmitting torque between the top joint member and the bottom joint member through the helical body;
wherein,
the cable extends through helical body and is secured at each of the opposite ends of the helical body; and
the cable is untensioned when the helical body is in a relaxed position, thus allowing helical body to extend or bend in response to an applied force while limiting further deflection of the helical body when under tension.

22. The method of claim 17, wherein the articulating joint further comprises:
a first plurality of arms axially extending from the top joint member; and
a second plurality of arms axially extending from the bottom joint member;
wherein the first plurality of arms are intermeshed with the second plurality of arms for transmission of rotational motion between the top and bottom joint members.

23. The method of claim 22, further comprising restricting separation of the top joint member and the bottom joint member using the cable, without connecting the first plurality of arms and the second plurality of arms to each other with a fastener.

24. The method of claim 17, further comprising transferring at least a portion of the torque applied to the upper joint member to the lower joint member by shear stress in the cable.

25. The method of claim 24, wherein the top joint member and the bottom joint member have spaced apart, intermeshing arms that allow the top joint member and the bottom joint member to rotate with respect to each other a predetermined distance before the intermeshing arms contact; and wherein the method further comprises initially transferring torque from the top joint member to the bottom joint member by twisting the cable to increase tension until the arms make contact and transferring a balance of the torque with the arms.

26. The method of claim 17, further comprising bending the cable when a longitudinal axis of the top joint member is deflected relative to a longitudinal axis of the bottom joint member.
